(19) United States
(12) Patent Application Publication
(10) Pub. No.: US 2024/0037580 A1
(43) Pub. Date: Feb. 1, 2024

(54) DEAL FORECASTING WITHIN A COMMUNICATION PLATFORM

(71) Applicant: Zoom Video Communications, Inc., San Jose, CA (US)

(72) Inventors: Andrew Miller-Smith, Chicago, IL (US); Stephen Muchovej, Bishop, CA (US)

(21) Appl. No.: 17/878,013

(22) Filed: Jul. 31, 2022

(51) Int. Cl. G06Q 30/02; G06Q 30/00

(52) U.S. Cl. CPC G06Q 30/0202; G06Q 30/0201; G06Q 30/018

(57) ABSTRACT

Methods and systems provide for deal forecasting within a communication platform. In one embodiment, the system processes a communication session to provide analytics data for the session; receives internal data associated with a user of a communication platform pertaining to a deal, the internal data including internal analytics data for the deal derived from the communication session and one or more additional communication sessions; receives, from a CRM platform, updated CRM data pertaining to the deal; ingests the internal data and the updated CRM data into a standardized data repository; determines, via a model trained on the standardized internal data and updated CRM data, an outcome prediction for the deal; and provides, to one or more client devices, access to a presentation of the outcome prediction for the deal.

### FIELD OF INVENTION

The present invention relates generally to digital communication, and more particularly, to systems and methods for providing deal forecasting within a communication platform.

### SUMMARY

The appended claims may serve as a summary of this application.

### BRIEF DESCRIPTION OF THE DRAWINGS

The present invention relates generally to digital communication, and more particularly, to systems and methods for providing deal forecasting within a communication platform.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating examples of deals with their associated probability of closure.

FIG. 4 is a diagram illustrating one exemplary process for providing deal forecasting within a communication platform.

FIG. 5 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Digital communication tools and platforms have been essential in providing the ability for people and organizations to communicate and collaborate remotely, e.g., over the internet. In particular, there has been massive adopted use of video communication platforms allowing for remote video sessions between multiple participants. Video communications applications for casual friendly conversation (“chat”), webinars, large group meetings, work meetings or gatherings, asynchronous work or personal conversation, and more have exploded in popularity.

With the ubiquity and pervasiveness of remote communication sessions, a large amount of important work for organizations gets conducted through them in various ways. For example, a large portion or even the entirety of sales meetings, including pitches to prospective clients and customers, may be conducted during remote communication sessions rather than in-person meetings. Sales teams will often dissect and analyze such sales meetings with prospective customers after they are conducted. Because sales meetings may be recorded, it is often common for a sales team to share meeting recordings between team members in order to analyze and discuss how the team can improve their sales presentation skills.

Such techniques are educational and useful, and can lead to drastically improved sales performance results for a sales team. However, such recordings of meetings simply include the content of the meeting, and the communication platforms which host the meetings do not provide the sorts of post-meeting, or potentially in-meeting, intelligence and analytics that such a sales team would find highly relevant and useful to their needs.

Particularly, there is currently no way to use the insights from sales calls in internal meetings to predict aspects related to a deal. For example, one such aspect may be whether a deal or sales opportunity will “close”, i.e., that the deal will no longer be pending but will have resolved either as a successfully obtained deal, or as an unsuccessful closure without a deal taking place. There are existing tools to perform predictions based on customer relations management (“CRM”) data. Such tools may be CRM platforms which provide various CRM tools with respect to deals. Such platforms may, in some cases, leverage CRM data to predict, for example, whether a deal will close, how long it will take, what the revenue of the deal will be upon closing, and more. However, such tools do not current provide a connection between meeting data and CRM data. They lack the ability to analyze meetings, then use that meeting analytics data in tandem with CRM data to provide deal and deal-adjacent forecasting which can be performed more accurately or solely with the combination of this data.

Thus, there is a need in the field of digital communication tools and platforms to create a new and useful system and method for providing deal forecasting within a communication platform. The source of the problem, as discovered by the inventors, is a lack of ability for the system to use both meeting analytics data and CRM data in tandem to perform deal forecasting.

In one embodiment, the system processes a communication session to provide analytics data for the session; receives internal data associated with a user of a communication platform pertaining to a deal, the internal data including internal analytics data for the deal derived from the communication session and one or more additional communication sessions; receives, from a CRM platform, updated CRM data pertaining to the deal; ingests the internal data and the updated CRM data into a standardized data repository; determines, via a model trained on the standardized internal data and updated CRM data, an outcome prediction for the deal; and provides, to one or more client devices, access to a presentation of the outcome prediction for the deal.

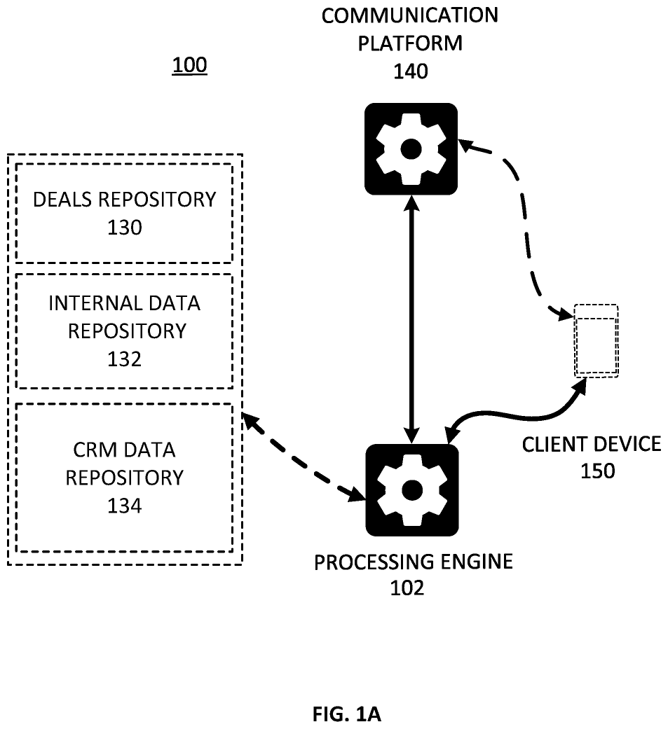

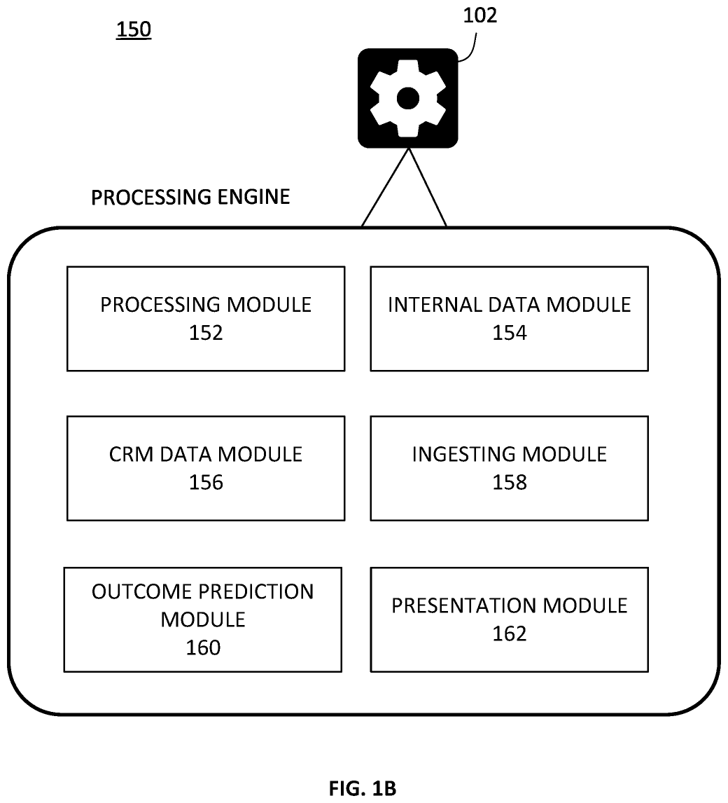

FIG. 1A is a diagram illustrating an exemplary environment in which some embodiments may operate. In the exemplary environment 100, a client device 150 is connected to a processing engine 102 and, optionally, a communication platform 140. The processing engine 102 is connected to the communication platform 140, and optionally connected to one or more repositories and/or databases, including, e.g., a deals repository 130, internal data repository 132, and/or CRM data repository 134. One or more of the databases may be combined or split into multiple databases. The user's client device 150 in this environment may be a computer, and the communication platform 140 and processing engine 102 may be applications or software hosted on a computer or multiple computers which are communicatively coupled via remote server or locally.

The exemplary environment 100 is illustrated with only one client device, one processing engine, and one communication platform, though in practice there may be more or fewer additional client devices, processing engines, and/or communication platforms. In some embodiments, the client device(s), processing engine, and/or communication platform may be part of the same computer or device.

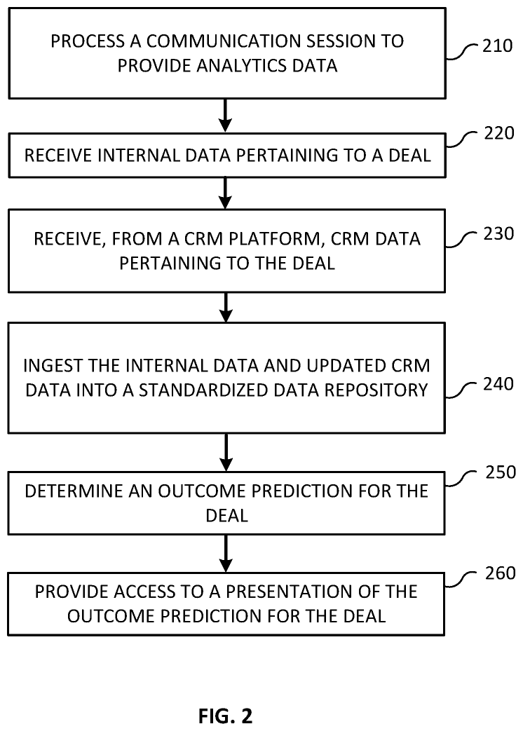

In an embodiment, the processing engine 102 may perform the exemplary method of FIG. 2 or other method herein and, as a result, provide deal forecasting within a communication platform. In some embodiments, this may be accomplished via communication with the client device, processing engine, communication platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device with a display configured to present information to a user of the device who is a participant of the video communication session. In some embodiments, the client device presents information in the form of a visual UI with multiple selectable UI elements or components. In some embodiments, the client device 150 is configured to send and receive signals and/or information to the processing engine 102 and/or communication platform 140. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 102 and/or communication platform 140 may be hosted in whole or in part as an application or web service executed on the client device 150. In some embodiments, one or more of the communication platform 140, processing engine 102, and client device 150 may be the same device. In some embodiments, the user's client device 150 is associated with a first user account within a communication platform, and one or more additional client device(s) may be associated with additional user account(s) within the communication platform.

In some embodiments, optional repositories can include a deals repository 130, internal data repository 132, and/or CRM data repository 134. The optional repositories function to store and/or maintain, respectively, deals associated with a user of the communication platform; internal data pertaining to the deals; and CRM data pertaining to the deals for one or more CRM platforms associated with the user. The optional database(s) may also store and/or maintain any other suitable information for the processing engine 102 or communication platform 140 to perform elements of the methods and systems herein. In some embodiments, the optional database(s) can be queried by one or more components of system 100 (e.g., by the processing engine 102), and specific stored data in the database(s) can be retrieved.

Communication platform 140 is a platform configured to facilitate meetings, presentations (e.g., video presentations) and/or any other communication between two or more parties, such as within, e.g., a video conference or virtual classroom. A video communication session within the communication platform 140 may be, e.g., one-to-many (e.g., a participant engaging in video communication with multiple attendees), one-to-one (e.g., two friends remotely communication with one another by video), or many-to-many (e.g., multiple participants video conferencing with each other in a remote group setting).

FIG. 1B is a diagram illustrating an exemplary computer system 150 with software modules that may execute some of the functionality described herein. In some embodiments, the modules illustrated are components of the processing engine 102.

Processing module 152 functions to process a communication session to provide analytics data for the session.

Internal data module 154 functions to receive internal data associated with a user of a communication platform pertaining to a deal, the internal data including internal analytics data for the deal derived from the communication session and one or more additional communication sessions.

CRM data module 156 functions to receive, from a CRM platform, updated CRM data pertaining to the deal.

Ingesting module 158 functions to ingest the internal data and the updated CRM data into a standardized data repository.

Outcome prediction module 160 functions to determine, via a model trained on the standardized internal data and updated CRM data, an outcome prediction for the deal.

Presentation module 162 functions to provide, to one or more client devices, access to a presentation of the outcome prediction for the deal.

The above modules and their functions will be described in further detail in relation to an exemplary method below.

FIG. 2 is a flow chart illustrating an exemplary method that may be performed in some embodiments.

At step 210, the system processes a communication session to provide analytics data for the session.

In some embodiments, the system connects a client device associated with a user of a communication platform to the communication session via the communication platform. In some embodiments, the system then presents a UI within the client device, the UI being associated with the particular communication session that the client device is currently connected to. In other embodiments, the system does not connect to a communication session nor present a UI for that session, but rather proceeds to process an already concluded or terminated communication session in order to provide analytics data for that session.

With respect to a communication session, either being conducted currently or completed, the client device has connected to the session with one or more other participants to the communication session. The communication session may represent, for example, an instance of a video conference, webinar, informal chat session, or any other suitable session which has been initiated and hosted via the video communication platform for the purpose of remotely communicating with one or more users of the video communication platform, i.e., the participants within the communication session. Participants are connected to the session via user devices, and are associated with user accounts within the communication platform.

In some embodiments, the participants are connected remotely within a virtual communication room generated by the communication platform. This virtual communication room may be, e.g., a virtual classroom or lecture hall, a group room, a breakout room for subgroups of a larger group, or any other suitable communication room which can be presented within a communication platform. In some embodiments, synchronous or asynchronous messaging may be included within the communication session, such that the participants are able to textually “chat with” (i.e., send messages back and forth between) one another in real time.

The system processes the communication session in various ways to provide analytics data for the session. The system may perform one or more machine learning tasks, rule-based tasks, or some combination thereof to provide analytics data for the session. The processing and analytics data will be described in further detail below with respect to step 220.

At step 220, the system receives internal data associated with a user of a communication platform pertaining to a deal, the internal data including internal analytics data for the deal derived from the communication session and one or more additional communication sessions. In some embodiments, the internal data represents one or more pieces of data which relate to a deal associated with the user of the communication platform. A “deal” or “opportunity” as used herein may refer to a sales opportunity, a non-sales opportunity, a matter associated with a prospective or existing client or customer, one or more meetings which may be designated as, e.g., a sales meeting, product pitch, or customer acquisition meeting, or any other suitable deal, opportunity, or matter which may include a successful sale, client or customer acquisition, or similar outcome.

In some embodiments, the internal data pertaining to the deal is associated with one or more meetings. The communication platform may associate between deal information and meetings which are directed towards progression of the deal. In some embodiments, a customer may share one or more pieces of internal data with the communication platform, or the communication platform may collect or generate internal data for the user of the platform as a result of the communication sessions which take place on the platform which the user has attended or hosted. In some embodiments, the communication platform recognizes that the user in question is a salesperson or part of a sales team, as opposed to, e.g., a customer or other non-sales-oriented user.

In some embodiments, either during a current communication session or after a session has ended, the system may process information related to the meeting in order to generate one or more pieces of analytics data. In some embodiments, each meeting within the communication platform is associated with the user's account within the platform, and therefore has the user's identification (“ID”) associated with it. In some embodiments, the system further associates a given communication session with a deal ID.

Information related to the meeting may include, e.g., a transcript generated for the meeting, including utterances between speakers present at the meeting; video content representing frames of video capturing the communication session, including, e.g., presentation slides, video feeds of participants, or any other visible content; data representing user engagement, and more. The processing and analysis performed on such data may, in some embodiments, lead to internal analytics data such as, e.g., an engagement score, a sentiment score, the number of next steps phrases uttered during the communication session, sales representative to customer speaking ratio, number of competitor mentions, the meeting duration in minutes, or any other suitable analytics data which may be derived from a communication session. In some embodiments, such internal analytics data relates to the meeting as a whole, as opposed to a particular segment of the meeting or utterance within the meeting. In some embodiments, only a subset of the deals associated with the user have associated meetings and meeting-based analytics data.

In some embodiments, at least a subset of the internal analytics data is derived from one or more machine learning (“ML”) techniques. For example, one or more ML models may provide one or more predictions related to the deal and/or the communication session based on input data related to the deal and/or communication session, with those predictions forming the internal analytics data. In some embodiments, this is facilitated by a robust ML pipeline whereby artificial intelligence (“Al”) services may be requested by various elements of the pipeline, and prediction results are returned in response. In some embodiments, ML models may be trained on data related to deals and current or past meetings. In some embodiments, the current session alone may be used as training data, while in other embodiments, other previous communication sessions may provide historical data which is used by the ML models for training. In some embodiments, previous communication sessions may be related or unrelated to the deal.

At step 230, the system receives, from a CRM platform, updated CRM data pertaining to the deal.

As used herein, CRM is a technology for managing a user's relationships and interactions with customers and potential customers. A CRM platform is a system or tool which assists with aspects of the customer relationship, such as, e.g., tracking of deals through various stages, contact management, sales management, agent productivity, and more. Such tools may be used throughout the entire customer lifecycle, spanning marketing, sales, digital commerce, and/or customer service interactions. In some instances, a CRM platform may provide a unified customizable dashboard to a user which provides the user with various pieces of information, including information about a customer or potential customer, a deal or multiple deals associated with a customer or potential customer, and more. Deals may be tracked along stages such as, e.g., discovery call completed, meeting scheduled, proposal requested, deal closed and won, and deal closed and lost.

In some embodiments, CRM data may be received by the system via an integration between the system and the CRM platform, which enables a user of the communication platform with authorized access to their associated CRM platform account to share data between the communication platform and CRM platform. In some embodiments, multiple integrations between the communication platform and CRM platforms may exist for a single user of the communication platform. In some embodiments, CRM platforms can provide the communication platform with rich and detailed data regarding, e.g., the inception, progress, value of, and conclusion of deals.

In various embodiments, the CRM data includes data relating to one or more of: deal history, stage of the deal, one or more associated products, one or more associated salespersons, and/or associated customer. In various embodiments, the CRM data includes one or more of: company size, customer budget, customer industry, salesperson experience, contract duration, and type of deal. In some embodiments, the type of deal may be represented as a subscription-based deal, or a non-subscription-based deal.

For example, CRM data may include a “Stage Name” for deals, which may be, e.g., qualification, discovery, solution, proof, agreement, finalized, closed won, or closed lost; an “Amount”, which may represent the deal amount in US dollars; an opportunity ID within the CRM platform; and more.

In some embodiments, a CRM platform may have data relating to so-called “stale deals” which have not progressed in, e.g., months or years. In some embodiments, the system discards data related to such stale deals in order to filter to only deals which are relevant to analysis.

At step 240, the system ingests the internal data and the updated CRM data into a standardized data repository. This step relates to standardizing the internal data and the updated CRM data into a standardized format which is recognizable and usable by the system, not just by the CRM platform or user's internal systems.

The system may standardize the data into multiple tables. In various embodiments, such tables may be updatable, append only, or otherwise modifiable with our without limitations or unmodifiable. The standardized data may include, for example, a customer table with such elements as, e.g., user account ID, customer ID, company name, company size in terms of people, company size in terms of budget, company industry, and date created; a salesperson table with user account ID, salesperson ID, title, experience in years, and date created; a product table with user account ID, product ID, product name, product description, create time, update time, and date created; meeting table, with user account ID, meeting ID, opportunity ID, meeting duration in minutes, meeting start time, participants, and data; activity table, with user account ID, activity ID, deal ID, subject, contact ID, source, status, whether the deal is closed or not, create time, start time, end time, and date; a meeting analysis table, with user account ID, meeting ID, host ID, account ID, participants, ML results, ML features, and date; and any other suitable standardized tables or data represented within the tables.

In some embodiments, ingesting the internal data and the updated CRM data into the standardized data repository is performed periodically at a prespecified time interval. For example, in some embodiments, this ingestion is set to occur once every 4 hours. During that time, the ingestion occurs such that any updates to the CRM data are reflected in the standardized data repository, and data related to any current or recent meetings which have not yet been added to the standardized data repository is added. In some embodiments, the prespecified time interval is modifiable by one or more users with permission to modify the prespecified time interval.

At step 250, the system determines, via a model trained on the standardized internal data and updated CRM data, an outcome prediction for the deal. Both the internal analytics data on meetings associated with deals, and the CRM data pertaining to the deals are used to predict one or more outcome predictions. The standardized versions of this data from the standardized data repository are used in a systematic way to perform this outcome prediction.

In some embodiments, with respect to the CRM data, for each deal, the system calculates the days it has spent in each deal stage, then computes an exponentially weighted average of that value. For example, if a deal has spent 10 days in stage 3, 5 days in stage 2, and 3 days in stage 1, then the exponentially weighted average for that row in which the deal is in stage 3 would be: 0.5*10+0.25*5*0.125*3. In some embodiments, the system discards all deals with a weighted duration of greater than or equal to 120 days in order to remove stale, effectively irrelevant deals from the analysis. In some embodiments, the system then converts the amount column to a logarithmic scale. In some embodiments, the resulting features may be, e.g., owner name, stage, weighted stage duration in days, and logarithmic amount.

In some embodiments, with respect to the internal data, the system computes the meeting features via exponentially weighted averaging, just as is employed for the stage duration of deals. Communication sessions associated with each deal are ordered by date, and the analytics data from recent communication sessions are weighted more heavily than those from past sessions which are not recent. In some embodiments, the resulting features may be, for example: weighted meeting duration, weighted engagement score, weighted number of next steps phrases mentioned, weighted sentiment score, weighted representative to customer talk ratio, and weighted number of competitor mentions.

In some embodiments, the model uses logistic regression to provide predictions related to a deal. For example, logistic regression can be used to predict whether a deal will close successfully or not. In some embodiments, the model passes through a hyperparameter tuning algorithm, which selects the type and strength of regularization (e.g., L1 or L2) that maximizes training accuracy. In some embodiments, preprocessing code standardizes all non-categorial features to have zero mean and unit variance, and splits the data set into training and validation sets. Thus, the model can be used to predict, e.g., the probability that a sales organization or salesperson will win a deal. In some embodiments, this outcome prediction may be represented as a probability of closure, win chance, or similar. In some embodiments, this outcome prediction may be represented by bucketing deals into, e.g., low probability, medium probability, and high probability buckets.

In some embodiments, this determination occurs via the model at a prespecified time interval. In some cases, this time interval may be the same time interval which may be used for ingesting data into the standardized data repository.

In some embodiments, the model which performs the determination is a binary classification model. In other embodiments, the model which performs the determination is a non-binary classification model which determines which of a number of categories the outcome may be classified under. In yet other embodiments, the model which performs the determination is a regression model which can function to, e.g., generate a value of a deal or other outcome predictions. Many other such models or types of models may be contemplated.

At step 260, the system provides, to one or more client devices, access to a presentation of the outcome prediction for the deal.

In some embodiments, the outcome prediction for the deal represents whether the deal will be won or lost upon the deal entering a closing stage. In other embodiments, the outcome prediction for the deal represents one or more of: an expected closing date of the deal (e.g., how quickly the deal will close), expected profit from an ongoing deal or how much value the deal will be associated with upon close, a prediction and alert for whether the deal is at risk of closing unsuccessfully, and any other suitable outcome predictions which can be possible for the deal.

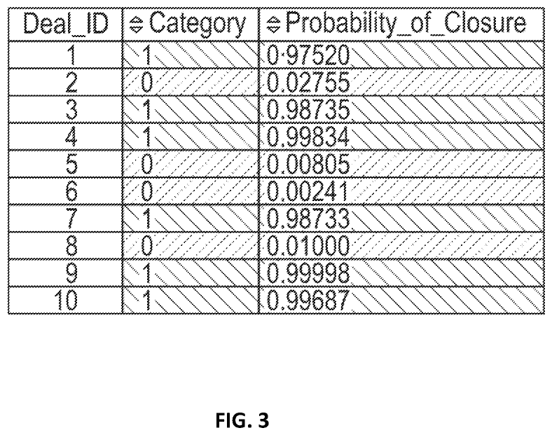

In some embodiments, the system provides access to, e.g., a user interface, section of a website, page, email, dashboard, or other means of displaying or presenting the outcome prediction of the deal. In some embodiments this may be presented immediately to a user, while in other embodiments a user may have access to such a presentation, but may opt to view the presentation at a later time as needed. In various embodiments, the presentation may take the form of an analytics page, prediction page, or other page with one or more pieces of data, visual elements such as graphs or charts, or other aspects or elements relevant to the presentation of the outcome prediction. In some embodiments, outcome predictions for multiple deals may be presented simultaneously, aggregated for presentation, or otherwise represented. An example of an outcome prediction being presented is illustrated with respect to FIG. 3.

FIG. 3 is a diagram illustrating examples of deals with their associated probability of closure. In the illustration, a chart is shown with a number of deals, represented as deal 1 through deal 10. Each deal is associated with a category of 0 or 1, which may be, for example, an indication of whether the deal is a subscription-based deal or not, whether the deal is a high-priority deal or not, or any other relevant category. An outcome prediction is also displayed for each deal, here labeled as a “probability of closure”. This outcome prediction represents the probability that each of the deals will close successfully, rather than close with the deal lost. For example, deal 1 has a probability of closure of 0.97520, representing approximately a 97.5% chance that the deal will close successfully, which predicts a high chance of the deal being won. In contrast, deal 2 has a probability of closure of 0.02755, representing approximately a 2.75% chance that the deal will close successfully, which predicts a very low chance of the deal being won. In some embodiments, a warning or notification may be presented to the user, either within the chart or via a more proactive alerting method such as an email notification or pop-up notification delivered to the user's client device.

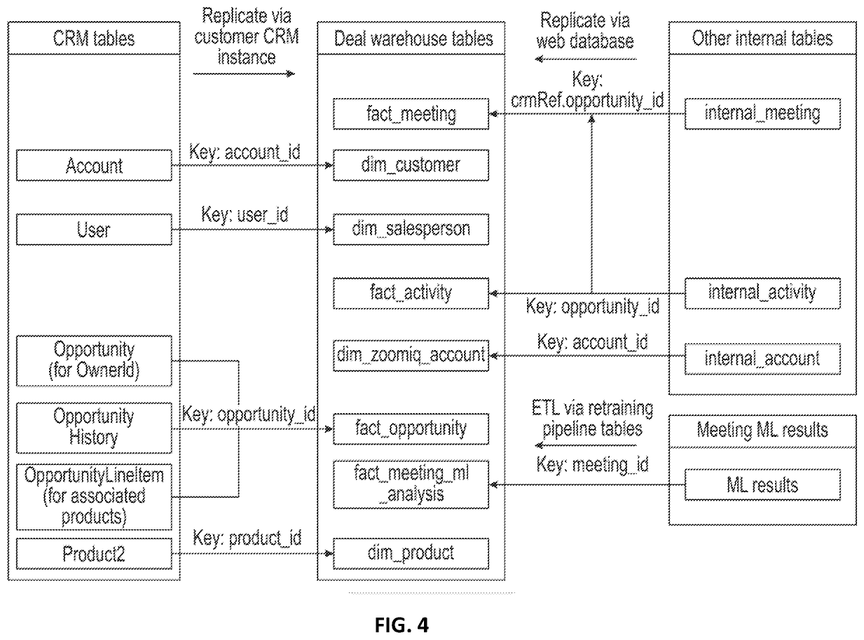

FIG. 4 is a diagram illustrating one exemplary process for providing deal forecasting within a communication platform. Within the diagram, the CRM tables on the left represent CRM data; the internal tables and meeting ML results on the right represent internal data, including ML-derived internal analytics data; and the tables in the center represent the standardized tables within the standardized data repository. The data from the CRM tables on the left and internal tables on right are normalized and ingested into the standardized data repository tables in the center. The CRM tables are replicated via a customer CRM instances through integration with the communication platform, and the internal tables are replicated via a web database. ML-derived internal analytics data can be ingested via retraining pipeline tables, in some instances.

The CRM data might include, for example, historical data, data about the progression of the deal, and more. This can be combined with the ML-derived internal analytics results from the communication sessions associated with that deal. For example, if the user has a meeting with company A, the system can, via the model for generate outcome predictions, match the internal data analytics of that meeting with historical records pertaining to the deal from the CRM data. Since all of the myriad data is standardized and collated into the standardized data repository, it can all be used systematically by the model in a collected, managed, and uniform fashion. The model can then be trained and fit based on the relevant parameters for the outcome prediction to be generated. The model can scan CRM data, ML-derived insights from meetings, and other relevant information. In some embodiments, for each user account, a unique model is trained and computed from the data that is ingested and standardized. The overall function of the model may be fixed, but the fit parameters may change from account to account. For example, how important the number of competitor mentions in a meeting is may be different for two different user accounts. For example, if one user company is focused on sales and their only competitor is a single startup, then this number may be less relevant for them compared to a user company which is situated in a very crowded market with multiple competitors.

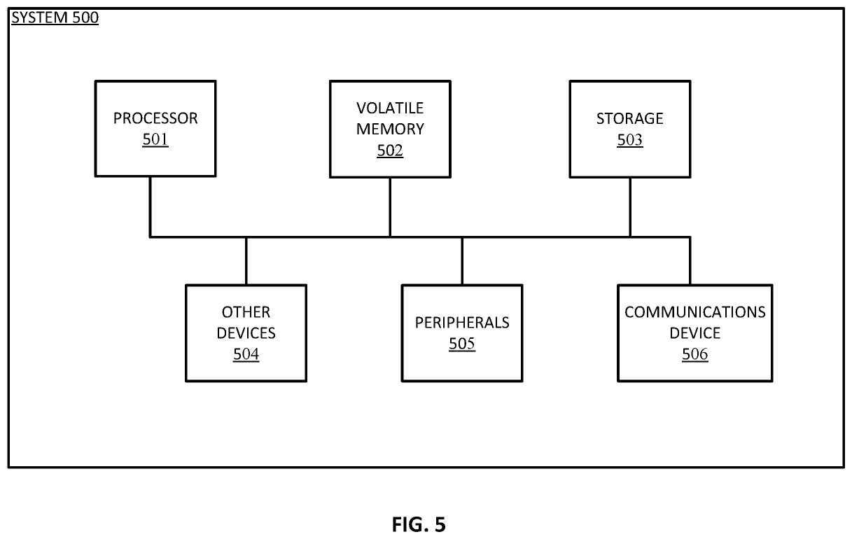

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

It will be appreciated that the present disclosure may include any one and up to all of the following examples.

Example 1. A method, comprising: processing a communication session to provide analytics data for the session; receiving internal data associated with a user of a communication platform pertaining to a deal, the internal data comprising internal analytics data for the deal derived from the communication session and one or more additional communication sessions; receiving, from a customer relationship management (CRM) platform, updated CRM data pertaining to the deal; ingesting the internal data and the updated CRM data into a standardized data repository; determining, via a model trained on the standardized internal data and updated CRM data, an outcome prediction for the deal; and providing, to one or more client devices, access to a presentation of the outcome prediction for the deal.

Example 2. The method of example 1, wherein the outcome prediction for the deal represents whether the deal will be won or lost upon the deal entering a closing stage.

Example 3. The method of any of examples 1-2, wherein at least a subset of the internal analytics data is derived from one or more machine learning (ML) techniques.

Example 4. The method of any of examples 1-3, wherein ingesting the internal data and the updated CRM data into the standardized data repository, determining the outcome prediction for the deal, and providing access to the presenting of the outcome prediction for the deal are all performed periodically at a prespecified time interval.

Example 5. The method of example 4, wherein the prespecified time interval is modifiable by one or more users with permission to modify the prespecified time interval.

Example 6. The method of any of examples 1-5, wherein the CRM data comprises one or more of: deal history, stage of the deal, one or more associated products, one or more associated salespersons, associated customer.

Example 7. The method of any of examples 1-6, wherein the CRM data comprises one or more of: company size, customer budget, customer industry, salesperson experience, contract duration, and type of deal.

Example 8. The method of example 7, wherein type of deal comprises one of: subscription-based deal, or non-subscription-based deal.

Example 9. The method of any of examples 1-8, wherein the internal analytics data comprises one or more of: engagement score, sentiment score, number of next steps, and number of competitor mentions.

Example 10. The method of any of examples 1-9, wherein the model is a binary classification model.

Example 11. The method of any of examples 1-10, wherein the model is a non-binary classification model.

Example 12. The method of any of examples 1-11, wherein the model is a regression model.

Example 13. The method of any of examples 1-12, wherein the outcome prediction for the deal represents expected profit from the deal.

Example 14. The method of any of examples 1-13, wherein the outcome prediction for the deal represents an expected closing data of the deal.

Example 15. The method of any of examples 1-14, wherein the outcome prediction for the deal represents a classification of the deal into one or more probabilities of closing successfully.

Example 16. A communication system comprising one or more processors configured to perform the operations of: processing a communication session to provide analytics data for the session; receiving internal data associated with a user of a communication platform pertaining to a deal, the internal data comprising internal analytics data for the deal derived from the communication session and one or more additional communication sessions; receiving, from a customer relationship management (CRM) platform, updated CRM data pertaining to the deal; ingesting the internal data and the updated CRM data into a standardized data repository; determining, via a model trained on the standardized internal data and updated CRM data, an outcome prediction for the deal; and providing, to one or more client devices, access to a presentation of the outcome prediction for the deal.

Example 17. The communication system of example 16, wherein the outcome prediction for the deal represents whether the deal will be won or lost upon the deal entering a closing stage.

Example 18. The communication system of any of examples 16-17, wherein at least a subset of the internal analytics data is derived from one or more machine learning (ML) techniques.

Example 19. The communication system of any of examples 16-18, wherein ingesting the internal data and the updated CRM data into the standardized data repository, determining the outcome prediction for the deal, and providing access to the presenting of the outcome prediction for the deal are all performed periodically at a prespecified time interval.

Example 20. The communication system of example 19, wherein the prespecified time interval is modifiable by one or more users with permission to modify the prespecified time interval.

Example 21. The communication system of any of examples 16-20, wherein the CRM data comprises one or more of: deal history, stage of the deal, one or more associated products, one or more associated salespersons, associated customer.

Example 22. The communication system of any of examples 16-21, wherein the CRM data comprises one or more of: company size, customer budget, customer industry, salesperson experience, contract duration, and type of deal.

Example 23. The communication system of example 22, wherein type of deal one of: subscription-based deal, or non-subscription-based deal.

Example 24. The communication system of any of examples 16-23, wherein the internal analytics data comprises one or more of: engagement score, sentiment score, number of next steps, and number of competitor mentions.

Example 25. The communication system of any of examples 16-24, wherein the model is a binary classification model.

Example 26. The communication system of any of examples 16-25, wherein the model is a non-binary classification model.

Example 27. The communication system of any of examples 16-26, wherein the model is a regression model.

Example 28. The communication system of any of examples 16-27, wherein the outcome prediction for the deal represents expected profit from the deal.

Example 29. The communication system of any of examples 16-28, wherein the outcome prediction for the deal represents an expected closing data of the deal.

Example 30. The communication system of any of examples 16-29, wherein the outcome prediction for the deal represents a classification of the deal into one or more probabilities of closing successfully.

Example 31. A non-transitory computer-readable medium containing instructions comprising: instructions for processing a communication session to provide analytics data for the session; instructions for receiving internal data associated with a user of a communication platform pertaining to a deal, the internal data comprising internal analytics data for the deal derived from the communication session and one or more additional communication sessions; instructions for receiving, from a customer relationship management (CRM) platform, updated CRM data pertaining to the deal; instructions for ingesting the internal data and the updated CRM data into a standardized data repository; instructions for determining, via a model trained on the standardized internal data and updated CRM data, an outcome prediction for the deal; and instructions for providing, to one or more client devices, access to a presentation of the outcome prediction for the deal.

Example 32. The method of example 31, wherein the outcome prediction for the deal represents whether the deal will be won or lost upon the deal entering a closing stage.

Example 33. The method of any of examples 1-32, wherein at least a subset of the internal analytics data is derived from one or more machine learning (ML) techniques.

Example 34. The method of any of examples 1-33, wherein ingesting the internal data and the updated CRM data into the standardized data repository, determining the outcome prediction for the deal, and providing access to the presenting of the outcome prediction for the deal are all performed periodically at a prespecified time interval.

Example 35. The method of example 34, wherein the prespecified time interval is modifiable by one or more users with permission to modify the prespecified time interval.

Example 36. The method of any of examples 1-35, wherein the CRM data comprises one or more of: deal history, stage of the deal, one or more associated products, one or more associated salespersons, associated customer.

Example 37. The method of any of examples 1-36, wherein the CRM data comprises one or more of: company size, customer budget, customer industry, salesperson experience, contract duration, and type of deal.

Example 38. The method of example 37, wherein type of deal comprises one of: subscription-based deal, or non-subscription-based deal.

Example 39. The method of any of examples 1-38, wherein the internal analytics data comprises one or more of: engagement score, sentiment score, number of next steps, and number of competitor mentions.

Example 40. The method of any of examples 1-39, wherein the model is a binary classification model.

Example 41. The method of any of examples 1-40, wherein the model is a non-binary classification model.

Example 42. The method of any of examples 1-41, wherein the model is a regression model.

Example 43. The method of any of examples 1-42, wherein the outcome prediction for the deal represents expected profit from the deal.

Example 44. The method of any of examples 1-43, wherein the outcome prediction for the deal represents an expected closing data of the deal.

Example 45. The method of any of examples 1-44, wherein the outcome prediction for the deal represents a classification of the deal into one or more probabilities of closing successfully.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

1. A method, comprising:
enabling a communication session between remote participant devices;
processing a transcript of the communication session to generate analytics data for the communication session, the transcript comprising a plurality of utterances associated with speaking participants within the communication session, and the analytics data including data representing engagement of the speaking participants and content of the communication session;
associating the communication session with a deal identification (ID);
deriving, from the generated analytics data and additional analytics data from one or more additional communication sessions, an engagement score pertaining to the deal ID;
receiving, from a customer relationship management (CRM) platform, updated CRM data comprising a plurality of historical record information pertaining to the deal ID;
ingesting the engagement score and the updated CRM data into a standardized data repository by at least converting, by an application server, the engagement score and the updated CRM data into a standardized data format, wherein converting is automatically performed periodically at a prespecified time interval;
determining, via a machine learning (ML) model trained on standardized engagement scores and updated CRM data, a stage of a deal associated with the deal ID;
determining a weighted average value of the stage of the deal based on a duration of time;
determining whether the deal is outdated based on the weighted average value of the stage of the deal being above a threshold;
determining a risk factor associated with closing the deal based on the weighted average value of the stage of the deal being below the threshold;
deleting data associated with a deal that is determined to be outdated from the standardized data repository; and
transmitting, to one or more client devices, a notification associated with the risk factor for display on a respective user interface of the one or more client devices.

2. The method of claim 1, further comprising:
determining an outcome prediction for the deal that represents whether the deal will be won or lost upon the deal entering a closing stage.

3. The method of claim 1, wherein the engagement score is derived from one or more ML techniques.

4. The method of claim 1, wherein the ML model is further trained on one or more parameters for an outcome prediction.

5. The method of claim 1, wherein ingesting the engagement score and the updated CRM data into the standardized data repository is performed periodically at a prespecified time interval, and wherein the prespecified time interval is modifiable.

6. The method of claim 1, wherein the updated CRM data comprises one or more of: a deal history, a stage of the deal, one or more associated products, one or more associated salespersons, and an associated customer.

7. The method of claim 1, wherein the updated CRM data comprises one or more of: a company size, a customer budget, a customer industry, a salesperson experience, a contract duration, and a type of deal.

8. The method of claim 1, wherein the updated CRM data comprises a type of deal, and wherein the type of deal comprises one of: a subscription-based deal, or a non-subscription-based deal.

9. The method of claim 1, further comprising:
ingesting one or more of: a sentiment score, a number of next steps, and a number of competitor mentions.

10. The method of claim 1, wherein the ML model is a binary classification model.

11. The method of claim 1, wherein the ML model is a non-binary classification model.

12. The method of claim 1, wherein the ML model is a regression model.

13. The method of claim 1, further comprising:
determining an outcome prediction for the deal that represents an expected profit from the deal.

14. The method of claim 1, further comprising:
determining an outcome prediction for the deal by calculating a number of days at each stage of the deal.

15. The method of claim 1, further comprising:
determining an outcome prediction for the deal that represents a classification of the deal into one or more probabilities of closing successfully.

16. A communication system, comprising:
a processor configured to:
enable a communication session between remote participant devices;
process a transcript of the communication session to generate analytics data for the communication session, the transcript comprising a plurality of utterances associated with speaking participants within the communication session, and the analytics data including data representing engagement of the speaking participants and content of the communication session;
associate the communication session with a deal identification (ID);
derive, from the generated analytics data and additional analytics data from one or more additional communication sessions, an engagement score pertaining to the deal ID;
receive, from a customer relationship management (CRM) platform, updated CRM data comprising a plurality of historical record information pertaining to the deal ID;
ingest the engagement score and the updated CRM data into a standardized data repository;
convert the engagement score and the updated CRM data into a standardized format automatically and periodically at a prespecified time interval;
determine, via a machine learning (ML) model trained on standardized engagement scores and updated CRM data, a stage of a deal associated with the deal ID;
determine a weighted average value of the stage of the deal based on a duration of time;
determine whether the deal is outdated based on the weighted average value of the stage of the deal being above a threshold;
determine a risk factor associated with closing the deal based on the weighted average value of the stage of the deal being below the threshold;
delete data associated with a deal that is determined to be outdated from the standardized data repository; and
transmit, to one or more client devices, a notification associated with the risk factor for display on a respective user interface of the one or more client devices.

17. The communication system of claim 16, wherein the processor is further configured to:
determine an outcome prediction for the deal that represents whether the deal will be won or lost upon the deal entering a closing stage.

18. The communication system of claim 16, wherein the engagement score is derived from one or more ML techniques.

19. The communication session of claim 16, wherein the ML model is further trained on insights from one or more conferences.

20. A non-transitory computer-readable medium comprising instructions, that when executed by a processor, cause the processor to perform operations comprising:
enabling a communication session between remote participant devices;
processing a transcript of the communication session to generate analytics data for the communication session, the transcript comprising a plurality of utterances associated with speaking participants within the communication session, and the analytics data including data representing engagement of the speaking participants and content of the communication session;
associating the communication session with a deal identification (ID);
deriving, from the generated analytics data and additional analytics data from one or more additional communication sessions, an engagement score pertaining to the deal ID;
receiving, from a customer relationship management (CRM) platform, updated CRM data comprising a plurality of historical record information pertaining to the deal ID;
ingesting the engagement score and the updated CRM data into a standardized data repository by at least converting, by an application server, the engagement score and the updated CRM data into a standardized data format, wherein converting is automatically performed periodically at a prespecified time interval;
determining, via a machine learning (ML) model trained on standardized engagement scores and updated CRM data, a stage of a deal associated with the deal ID;
determining a weighted average value of the stage of the deal based on a duration of time;
determining whether the deal is outdated based on the weighted average of the stage of the deal being above a threshold;
determining a risk factor associated with closing the deal based on the weighted average value of the stage of the deal being below the threshold;
deleting data associated with a deal that is determined to be outdated from the standardized data repository; and
transmitting, to one or more client devices, a notification associated with the risk factor for display on a respective user interface of the one or more client devices.
